(19) United States
(12) Patent Application Publication
(10) Pub. No.: US 2021/0207487 A1
(43) Pub. Date: Jul. 8, 2021

(54) TURBOMACHINE BLADING ANGULAR SECTOR WITH SEAL BETWEEN SECTORS

(71) Applicant: SAFRAN AIRCRAFT ENGINES, Paris (FR)

(72) Inventors: Alexis Hector Ulysse George, Moissy-Cramayel (FR); Christophe Scholtes, Moissy-Cramayel (FR); Antoine Robert Alain Brunet, Moissy-Cramayel (FR)

(73) Assignee: SAFRAN AIRCRAFT ENGINES, Paris (FR)

(21) Appl. No.: 17/056,707

(22) PCT Filed: May 20, 2019
(86) PCT No.: PCT/FR2019/051138

§ 371 Date: Nov. 18, 2020

(30) Foreign Application Priority Data
May 23, 2018 (FR) 1854335

(51) Int. Cl. F01D 9/04; F01D 11/12

(52) U.S. Cl. CPC F01D 9/041; F01D 11/001; F01D 11/122

(57) ABSTRACT

An angular sector of a fixed blading ring of a turbomachine, in particular of a stator or distributor, extends through a given angle about an axis A of the ring. The angular sector includes, with respect to axis A, a radially outer platform, a radially inner platform, at least two blades extending between the platforms, and at least one block of abradable honeycomb material. The abradable honeycomb material extends inwardly with respect to the inner platform between transverse ends of the sector and that comprises includes radially oriented tubular cells, in which the block of abradable material has at least one transverse end wall at which all of the cells are open by openings oriented away from the sector.

The invention relates to an angular sector of a turbomachine blading, in particular an blading angular sector of a rectifier equipping a compressor or a distributor equipping a turbine of this turbomachine.

### BACKGROUND

Gas turbine engines have, in a known manner, fixed internal blading rings, which are mounted in external casings of a primary flow duct of the engine and which are axially interposed between compressor moving blading wheels or between turbine moving blading wheels of these engines. Each fixed blading ring is dynamically sealed around a compressor or turbine rotor. For this purpose, each fixed blading ring comprises an internal block of abradable material which is designed to cooperate with lip sealing elements that are rotationally integral with the associated compressor or turbine rotor to ensure gas-tightness.

Part of the gas is nevertheless likely to enter between the stationary and moving blading of the compressor or turbine rotors, in the opposite direction to the main flow circulating in the primary flow duct.

The fixed internal blading ring constitute rectifiers when they are interposed between compressor wheels, or constitute distributors when they are interposed between turbine wheels.

In order to facilitate their assembly and reduce their manufacturing cost, the fixed blading rings are often made as an assembly of angular sectors that are juxtaposed next to each other to form a whole fixed blading ring. These rings thus leave an inter-sector clearance which leaves recirculation passages for the gases, no longer around the roots of the angular sectors, but between them.

Indeed, conventionally, part of the gases that pass through the fixed blading from upstream to downstream tend to recirculate from downstream to upstream through the seal that is made between the block of abradable material and the lip sealing element according to a leakage flow rate that one tries to keep as minimal as possible, because it affects the performance of the corresponding compressor or turbine. Another part of the gas that passes through these blading from upstream to downstream tends to recirculate from downstream to upstream by insinuating itself between the sectors through the clearance between the sectors, also called the inter-sector clearance.

The difficulty in ensuring a satisfactory level of sealing lies in the fact that the angular sectors of the ring move due to the mechanical and thermal deformations that occur during engine operation. Thus, the inter-sector clearance and leakage flow rate vary during engine operation. Furthermore, the clearance during hot engine operation must never be zero because contact between the sector platforms could cause ovalization of the casing, which is outside the fixed blading, and/or matting of the surfaces in contact, which could drastically increase the stresses exerted on the fixed blading, resulting in particular in a transfer of these stresses to the outer casing of the engine, which receives the fixed blading.

A transfer of these stresses could cause an ovalization of the outer casing and significantly modify the radial clearances between this casing and the adjacent moving blading, with a very negative impact on the engine in terms of service life.

Conventional sealing between two immediately adjacent angular sectors of a fixed blading ring is ensured by lip seal systems interposed between these sectors to limit leakage between sectors. These sealing systems can be used to seal ring sectors of the fixed blading in the primary flow duct, and also, in the case of a double-flow engine, to seal ring sectors of a fixed blading in the secondary flow duct.

In this technology, lips are housed between two adjacent sectors in housings that have been machined into the sectors. The lips are used to prevent the flow of gas of passing through the inter-sector clearance.

Conventionally, an angular sector of the blading ring comprises, with respect to the axis of the ring, a radially outer platform substantially in the shape of an angular section of a cylinder, a radially inner platform in the shape of an angular section of a cylinder, at least two vanes extending between said platforms, a root attached to the inner platform, and at least one block of abradable honeycomb material extending inwardly to the root, as described in FR-2.552.159-A1 and JP-2008/180149-A. The lips interposed between two sectors are embedded in the mass of the two adjacent roots of the two sectors and in housings facing the adjacent interior and exterior platforms of the two sectors. Documents FR-2.732.416-A1, EP-1.229.213-A1, and EP-0.017.534-A1 describe such configurations.

However, these lips are not easy to install. In addition, they require the construction of housings in the angular sectors of the fixed blading ring, which are expensive to manufacture.

In addition, the lips cannot be arranged along the entire radial thickness of the root for the sealing on the inside of the inner platform. Consequently, clearances remain between the sectors through which the gases can flow.

Therefore, there is a need for an alternative sealing technology to dispense with such lips and to improve the sealing between the ring sectors of a fixed blading.

### DESCRIPTION OF THE INVENTION

For this purpose, the invention proposes to take advantage of the block of abradable material arranged inside the inner platform to provide a seal directly between transverse end walls of two adjacent angular sectors of a fixed blading ring.

For this purpose, the invention provides an angular sector of a fixed blading ring of a turbomachine, in particular of a rectifier or distributor, said sector extending at a given angle around an axis A of the fixed blading ring and comprising, with respect to the axis A of said fixed blading ring, a radially outer platform, a radially inner platform, at least two vanes extending between said platforms, and at least one abradable honeycomb material block extending internally of the inner platform between transverse ends of the sector and comprising radially oriented tubular cells, characterized in that the abradable honeycomb material block comprises at least one transverse end wall at which all the cells are open via openings which face away from said sector.

According to other characteristics of the angular sector:

the abradable material block extends radially until the platform,

the openings of the cells are all arranged in the same plane of said wall,

the opening of each cell is of a width corresponding to a total width of said cell,

the cells are identical and polygonal in shape.

The invention also concerns an assembly of two adjacent angular sectors of the type described above, characterized in that the transverse end walls of said adjacent angular sectors comprise open cells which face each other and in that the cells of the end wall of one of said adjacent angular sectors are offset by a given offset in the axial direction with respect to those of the end wall of the other of said adjacent angular sectors.

According to other characteristics of the assembly:

the cells of the adjacent angular sectors are arranged in a staggered manner, the cells of the end wall of one of the adjacent angular sectors being offset in the axial direction with respect to those of the end wall of the other of the adjacent angular sectors by a given offset equal to half the width of a cell,

the plane of the openings of the cells in the end wall of one of the adjacent angular sectors forms a given clearance with the plane of the openings of the cells in the end wall of the other of the adjacent angular sectors,

the given clearance is zero or negative so that the open cells axially offset form baffles.

Finally, the invention concerns a fixed blading ring of a turbomachine comprising a plurality of angular sectors of the fixed blading ring, characterized in that it comprises a given number of sectors whose juxtaposition forms the entire fixed blading rings, in that each angular sector of the fixed blading ring comprises two opposite transverse end walls at which all cells are open and in that each angular sector of the fixed blading ring is assembled with each adjacent angular sector of the fixed blading ring to form an assembly of the type described above.

### DESCRIPTION OF FIGURES

The invention will be better understood and other details, characteristics and advantages of the present invention will appear more clearly when reading the following description made as an example, which is not limitative, and with reference to the appended drawings, in which:

FIG. 1 is a schematic sectional view of a turbomachine according to the prior art,

FIG. 2 is a detailed cross-sectional view of a turbine of the turbomachine in FIG. 1,

FIG. 3 is a detailed cross-sectional view of a compressor of the turbomachine in FIG. 1,

FIG. 4 is an end view of a turbine blading comprising an assembly of angular blading sectors according to the invention,

FIG. 5 is a perspective view of a blading sector according to the prior art,

FIG. 6A is a sectional view of the blading sector of FIG. 5,

FIG. 6B is a sectional view of a blading sector according to the invention,

FIG. 7 is a perspective view of an abradable material block assembly of two angular blading sectors,

FIG. 8 is a sectional view of an assembly with a clearance of abradable material blocks of two angular blading sectors,

FIG. 9 is a representative diagram of the flow rate of a recirculating flow passing through an assembly of angular blading sectors as a function of the clearance between these sectors,

FIG. 10A is a sectional view of an assembly with a high clearance of abradable material blocks of two angular blading sectors, and the recirculating gas flow passing through it,

FIG. 10B is a sectional view of an assembly with a reduced clearance of abradable material blocks of two angular blading sectors, and the recirculating gas flow passing through it.

### DETAILED DESCRIPTION

In the following description, identical reference numbers refer to parts that are identical or have similar functions.

Axial direction means by extension any direction parallel to an axis A of a turbomachine, and radial direction means any direction perpendicular and extending radially with respect to the axial direction.

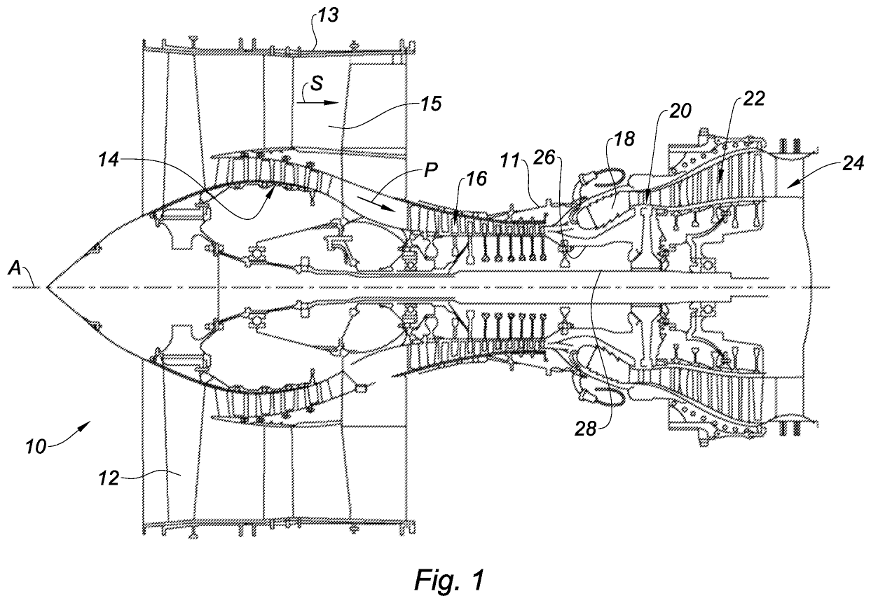

FIG. 1 shows a turbomachine 10 of axis A of the double flow type. Such a turbomachine 10, here a turbojet engine 10, comprises in a known manner a fan 12, a low pressure (LP) compressor 14, a high pressure (HP) compressor 16, a combustion chamber 18, a high pressure (HP) turbine 20, a low pressure (LP) turbine 22 and an exhaust nozzle 24. The rotor of the HP compressor 16 and the rotor of the HP turbine 20 are connected by a high pressure HP shaft 26 and form a high pressure body with it. The rotor of the LP compressor 14 and the rotor of the low pressure LP turbine 22 are connected by a shaft LP 28 and form with it a low pressure body.

A primary air flow “P” passes through the high- and low-pressure bodies and fan 12 produces a secondary air flow “S” that circulates in the turbojet engine 10, between a casing 11 and an outer casing 13 of the turbojet engine, in a cold flow channel 15. At the outlet of nozzle 24, the gases from the primary flow “P” are mixed with the secondary flow “S” to produce a propulsion force, the secondary flow “S” providing most of the thrust here.

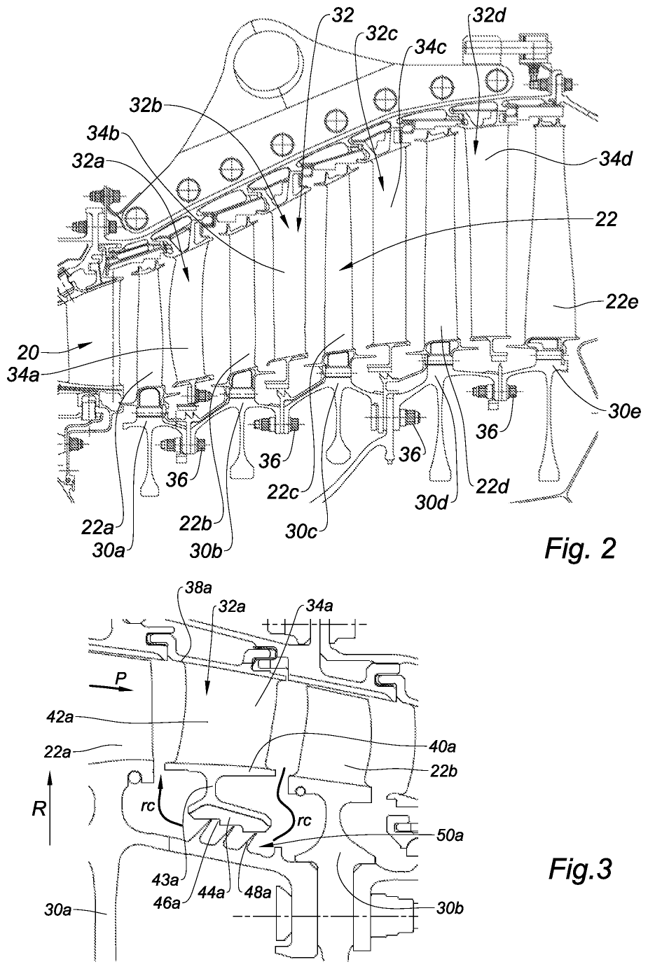

The LP and HP compressors 14, 16, and the HP and LP turbines 20, 22 each have several compressor or turbine stages respectively. As shown for example in FIG. 2, the LP 22 turbine comprises several turbine moving blading wheel 22a, 22b, 22c, 22d, 22e whose blading are carried by associated shrouds 30a, 30b, 30c, 30d, 30e which are assembled together by bolts 36.

The LP turbine 22 also comprises fixed blading rings 32a, 32b, 32c, 32d of a blading of a diffuser 32 which are interposed between the turbine moving blading wheels 22a, 22b, 22c, 22d, 22e.

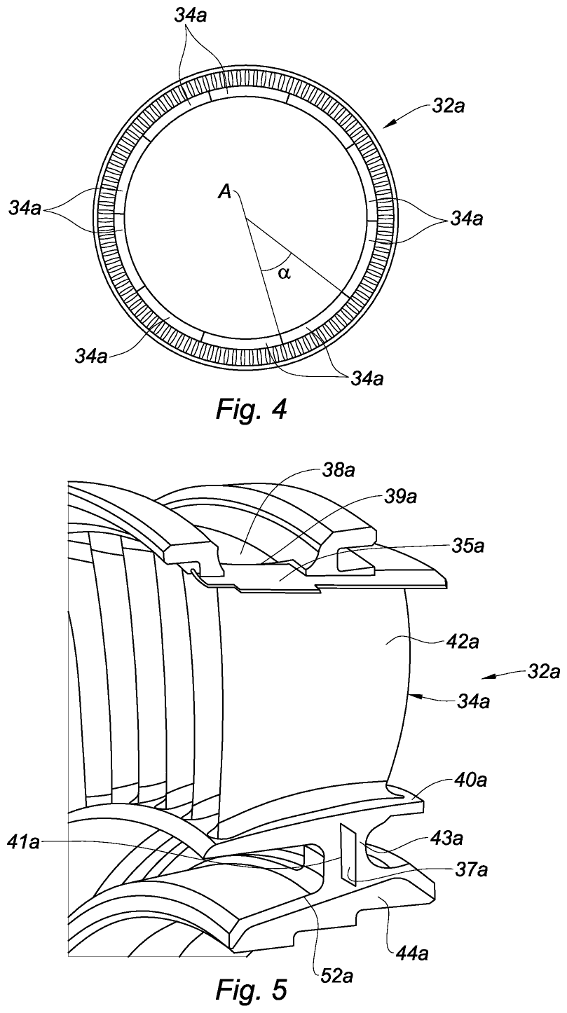

Each fixed blading ring 32a, 32b, 32c, 32d of a diffuser is formed of an assembly of sectors 34a, 34b, 34c, 34d of fixed blading rings, assembled around the axis A of the turbomachine on 360° so as to constitute a fixed blading ring 32a, 32b, 32c, 32d complete around the axis A. FIG. 4 shows as an example a diffuser blading 32a consisting of an assembly of ten blading sectors 34a.

In the same way, as illustrated in FIG. 3, a HP compressor 16 of the turbomachine 10 can comprise a series of compressor moving blading wheel 22a, 22b between which are interposed rectifier fixed blading rings 32a which are themselves made in the form of an assembly of angular sectors 34a of the fixed blading ring. It will therefore be understood that the invention applies to any assembly of angular sectors 34a of the fixed blading ring, whether they are angular sectors 34 of a rectifier intended for a compressor or angular sectors of a diffuser intended for a turbine.

As shown also in FIG. 3, a compressor fixed blading ring 32a consists of an assembly of angular sectors 34a of the blading ring. It can be seen that each fixed blading ring, and in particular the blading ring 32a, is placed in the primary flow duct P forming a clearance with the adjacent compressor wheel 22a and 22b, and in particular with shrouds 30a and 30b of these wheels 22a, 22b. Part of the pressurized gases of the primary flow P, which flows from upstream to downstream, tends to insinuate itself between the shrouds 30a and 30b and the angular sector 34a to recirculate from downstream to upstream according to a recirculation flow rc, represented by the arrows in FIG. 3, which tends to bypass the angular sector 34a.

The existence of this recirculation flow rc is particularly penalizing. The recirculation flow rc tends to reduce the performance of the turbine, or in the case of a compressor, the performance of said compressor. This is why current designs tend to minimize this recirculation flow rc by equipping the angular sector 34a with sealing means with the shroud it surrounds.

As shown in FIG. 4, each sector 34a extends at a given angle α around the axis of the ring 32a, which corresponds to the axis A of the turbomachine 10 previously illustrated in FIG. 1.

Any position close to the axis A in the radial direction is referred to as “lower” and any position further from the axis A in the radial direction than the lower position is referred to as “upper”. Finally, by “transverse” is meant any plane or surface comprising the axis A and parallel to a sectional plane of a sector 34.

Conventionally, as shown in FIG. 3, each sector 34a comprises, with respect to the axis A of the blading 32a, a radially outer platform 38a, a radially inner platform 40a, at least two vanes 42a which extend substantially in a radial direction R between said platforms 38a, 40a, a root 43a which extends radially inward from the inner platform 40a and at least one block 44a of abradable honeycomb material which therefore also extends inward to the inner platform 40a between transverse ends (not shown) of the angular sector 34a.

A radially inner radial sealing face 46a is configured to cooperate with sealing elements 48a of a labyrinth seal 50a carried by a rotor of the turbomachine, here the shroud 30a.

This configuration significantly reduces the intensity of the recirculation flow rc circulating between the sector 34a and the shroud 30a. However, it has no influence on the recirculation flow between two adjacent sectors 34a.

Conventionally, as shown in FIG. 5, the sealing between adjacent sectors 34a is achieved by means of lips 35a, 37a which are received in housings 39a, 41a which are arranged opposite each other between the sectors 34a to form a barrier to the recirculation flow rc between sectors 34a. For example, each sector 34a comprises an upper housing 39a, formed in its outer platform 38a, which receives a tangential lip 35a and a lower housing 41a formed in its root 43a, which receives a radial lip 37a. This configuration is particularly costly because it requires precise manufacturing tolerances of the housings 39a, 41a on the one hand, and because it imposes particular assembly precautions, especially with regard to the sectors that are intended to close the entire blading 32a during its assembly.

The invention proposes to simplify the sealing between the sectors 34a by taking advantage of the abradable material block 44a already present radially inside the sector 34a with respect to the inner platform 40a so as to provide a seal directly between transverse end walls 52a of two adjacent angular sectors 34a.

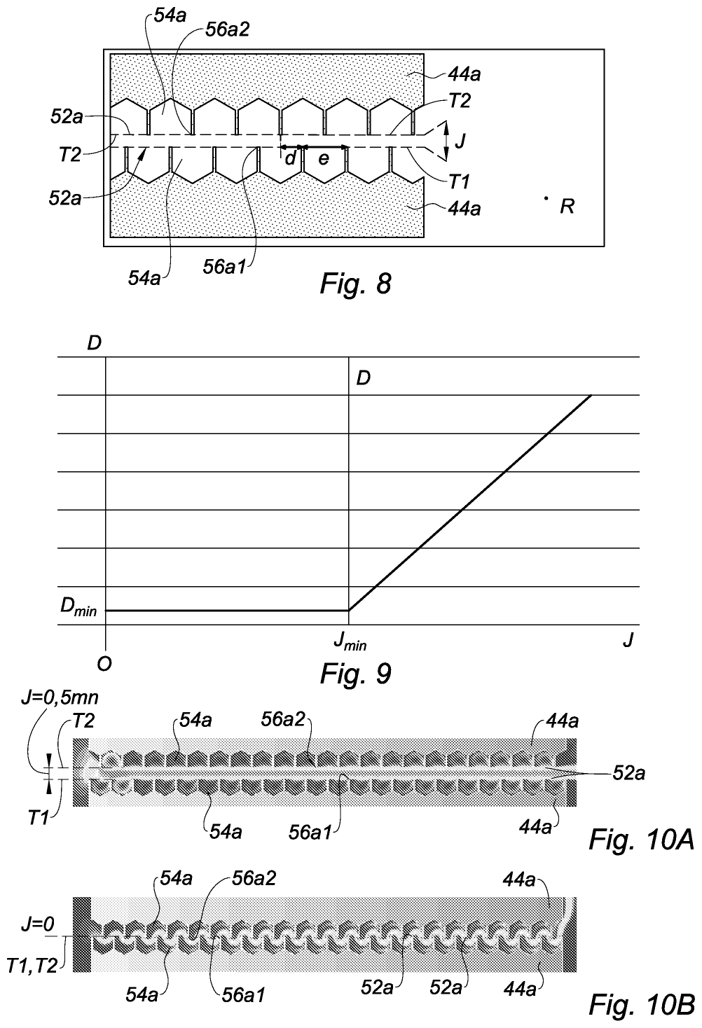

As illustrated in FIGS. 7 and 8, which show the assembly of two angular sectors 34a at their abradable material blocks 44a, the abradable honeycomb material of each block 44a comprising in a manner known per se tubular cells 54a oriented radially in the radial direction R. In accordance with the invention, at the transverse end wall 52a of one block 44a, which is intended to cooperate with the transverse end wall 52a of the other adjacent block 44a, all of the cells 54a are open through openings 56a1 which face away from the sector 44a in which they are formed and which cooperate with openings 56a2 formed in the wall 52a of the other block 44a of the adjacent sector 34a.

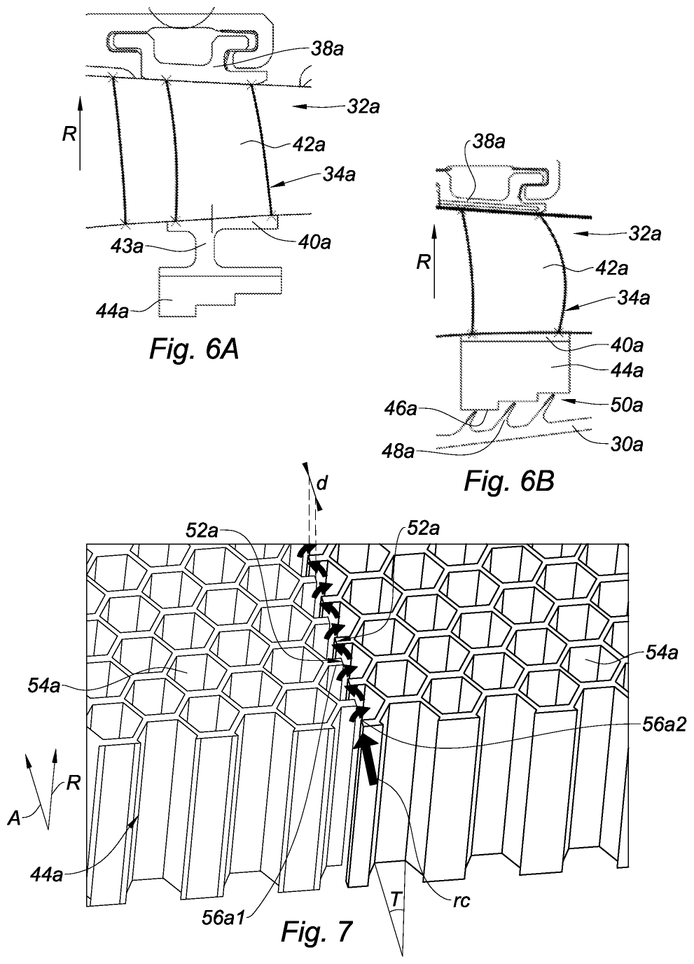

To ensure optimum reduction of the leakage flow rate rc under the inner platform 40a of the sector 34, the abradable material block 44a of the sector 34a, in the preferred embodiment of the invention, extends to the inner platform 40a. This configuration has been shown in FIG. 6B. Compared to a conventional angular sector 34a as shown in FIG. 6A, the root 43a has been removed and the abradable honeycomb material block 44a has been extended radially to the inner platform 40a so as to impart maximum height to the abradable honeycomb material block 44a, thereby providing maximum sealing. In addition, this configuration eliminates the need for a conventional lip sealing system between the roots 43a of the adjacent platforms.

As shown in FIGS. 7 and 8, the openings 56a1, 56a2 of the cells 54a are all arranged in the same associated plane T1, T2 of the wall 52a. The wall 52a can therefore be obtained very simply. In the preferred embodiment of the invention, the abradable honeycomb material of the block 44a is obtained by an additive manufacturing process. This configuration allows the formation of a wall 52a provided with regular cells 54a and a regular conformation of the openings 56a1, 56a2 without risk of deterioration during the manufacture of the wall 52a as could be the case using a material removal process.

Preferably, as shown in FIG. 8, the opening 56a1, 56a2 of each cell 54a is of a width corresponding to the total width I of said cell 54a. This configuration prevents the gas flow rc from being trapped in a cell and creating micro-turbulence that would disturb the gas flow.

The cells 54a can be cylindrical or polygonal in shape and can also be different from each other. However, it has been found that the optimal orientation of the openings 56a1, 56a2 is obtained when the cells 54a are identical and polygonal in shape.

In this configuration, an assembly of two adjacent angular sectors 44a as shown in FIGS. 7 and 8 can advantageously be obtained with cells 54a of the end wall 52 of one of said adjacent angular sectors 34a which are offset in the axial direction A by a given offset d with respect to those of the end wall 52a of the other of said adjacent angular sectors 34a. As shown in FIGS. 7 and 10B, this offset d creates a series of obstacles to the flow rc that slows down the flow rate. It is sufficient that the offset d has a non-zero value.

As shown in FIGS. 7 and 8, the cells 54a of adjacent angular sectors 44a are staggered, with the cells 54a of the end wall 52a of one of the adjacent angular sectors 44a being offset in the axial direction A relative to those of the end wall 52a of the other of the adjacent angular sectors 44a by an offset d equal to half the width I of a cell 54a.

As can be seen in FIG. 8, the plane T1 of the openings 56a1 of the cells in the end wall 52a of one of the adjacent angular sectors 44a forms a given clearance J with the plane T2 of the openings 56a2 of the cells 54a of the end wall 52a of the other of the adjacent angular sectors 44. This clearance J conditions the flow rate of the recirculation flow rc passing between the sectors.

As shown in FIG. 9, which represents a flow rate D of the flow rc as a function of the value of the clearance J, it can be seen that the flow rate D decreases as the clearance J decreases. From a minimum value Jmin of the clearance J, this flow D remains constant, minimal and equal to a minimum flow Dmin.

The clearance J can be zero as soon as the cells 54a are staggered, as shown in FIGS. 7 and 10B, because due to the offset of the cells 54a there is no risk of interference between the cells 54a. In this case, the axially offset open cells 54a form baffles that slow down the gas flow rc with maximum efficiency.

The clearance J can also be negative, in which case the cells 54a are nested within each other to form baffles.

FIG. 10A shows a gas flow rc corresponding to a 0.5 mm clearance J and FIG. 10B shows a gas flow rc corresponding to a zero clearance J. The flow rate rc is significantly reduced at zero clearance, and the flow rate can be reduced by almost 96%.

As seen in reference to FIG. 4, the fixed blading ring 32a comprises a given number of sectors 34a of a fixed blading rings whose juxtaposition forms the entire ring and it comprises at least two of these angular sectors 34a of a fixed blading ring with blocks 44a of abradable material 44a with open cells 54a. It will be understood that, of course, all sectors of the fixed blading ring preferably comprise blocks 44a with open cells 54a. Thus, each angular sector 34a of the fixed blading ring is assembled with each of the adjacent angular sectors 34a of the fixed blading rings in an assembly of the type described above, and each block 44a comprises opposite transverse end walls 52a at both ends which are shaped with open cells 54a.

The invention thus allows advantageously to ensure the sealing between angular sectors 32a of the fixed blading ring in a simple and effective manner, and to limit the flow rate of the recirculation flow rc between these angular sectors 32a, which allows to improve the performance of a compressor or a turbine equipped with such angular sectors 32a of a fixed blading ring in a consequent manner.

1. An angular sector of a fixed blading ring of a turbomachine, in particular of a rectifier or distributor, said sector extending at a given angle (α) around an axis A of and comprising, with respect to the axis A of said ring, a radially outer platform and a radially inner platform, at least two vanes extending between said platforms, and an abradable honeycomb material block extending internally of the inner platform between transverse ends of the sector and comprising radially oriented tubular cells,
wherein the abradable honeycomb material block comprises at least one transverse end wall at which all the cells are open via openings which face away from said sector.

2. The angular sector according to claim 1, wherein the abradable material block extends radially to the inner platform.

3. The angular sector according to claim 2, wherein the openings are arranged in a same plane of said wall.

4. The angular sector according to claim 1, wherein the opening of each cell is of a width corresponding to a total width of said cell.

5. The angular sector according to claim 1, wherein the cells are identical and polygonal in shape.

6. An assembly of two adjacent angular sectors according to claim 5, wherein the transverse end walls of said adjacent angular sectors comprise open cells which face each other and in that the cells of the end wall of one of said adjacent angular sectors are offset by a given offset in the axial direction with respect to those of the end wall of the other of said adjacent angular sectors.

7. The assembly of two adjacent angular sectors according to claim 6, wherein the cells of the adjacent angular sectors are arranged in a staggered manner, the cells of the end wall of one of the adjacent angular sectors being offset in the axial direction with respect to those of the end wall of the other of the adjacent angular sectors by a given offset equal to half the width of a cell.

8. The assembly of two adjacent angular sectors according to claim 6, wherein a plane of the openings of the cells of the end wall of one of the adjacent angular sectors forms a given clearance with a plane of the openings of the cells of the end wall of the other of the adjacent angular sectors.

9. The assembly of two adjacent angular sectors according to claim 8, wherein said given clearance is zero or negative so that the open cells axially offset form baffles.

10. A turbomachine fixed blading ring comprising a plurality of angular sectors of the fixed blading ring, comprising a given number of sectors whose juxtaposition forms the entire fixed blading ring, in that each angular sector of the fixed blading ring comprise two opposite transverse end walls at which all cells are open, and in that each angular sector of the fixed blading ring is assembled with each adjacent angular sectors of the fixed blading ring to form an assembly according to claim 6.
